(19) United States
(12) Patent Application Publication
(10) Pub. No.: US 2011/0019507 A1
(43) Pub. Date: Jan. 27, 2011

(54) CLOCKWORK MECHANISM AND CLOCKWORK TIMEPIECE

(75) Inventor: Toyonori MURAJI, Tokyo (JP)

Correspondence Address: KRATZ, QUINTOS & HANSON, LLP, 1420 K Street, N.W., 4th Floor, WASHINGTON, DC, 20005, US

(73) Assignee: SEIKO CLOCK INC., Tokyo (JP)

(21) Appl. No.: 12/764,303

(22) Filed: Apr. 21, 2010

(30) Foreign Application Priority Data
Jul. 27, 2009 (JP) 2009-174118

(51) Int. Cl. G04B 19/02

(52) U.S. Cl. 368/220

(57) ABSTRACT

A clockwork mechanism includes: a supporting member; a movable member including an engagement hole and movably supported by the supporting member; a drive pin engaging the engagement hole, including a flange portion for preventing the drive pin from disengaging from the engagement hole, and revolving to move the movable member; a biasing member provided in the movable member to partially overlap the engagement hole; and an abutment member abutting the movable member to restrict the movement of the movable member. The flange portion overlaps or does not overlap the biasing member depending on a revolving position of the drive pin. When the movable member abuts the abutment member, the drive pin pushes the biasing member and the movable member is biased toward the abutment member by the biasing member. When the flange portion does not overlap the biasing member, the drive pin moves the movable member to push the biasing member, allowing the drive pin to disengage from the engagement hole.

### CROSS-REFERENCE TO RELATED APPLICATION

This application is based upon and claims the benefit of priority of the prior Japanese Patent Application No. 2009-174118, filed on Jul. 27, 2009, the entire contents of which are incorporated herein by reference.

### BACKGROUND

(i) Technical Field

The present invention relates to a clockwork mechanism and a clockwork timepiece.

(ii) Related Art

Japanese Unexamined Utility Model Application Publication No. 9-332 discloses a timepiece having movable dial plates openable and closeable. In response to the opening or closing of the movable dial plates, an ornament is exposed or covered. The movable dial plates stop with abutting each other. To prevent any displacement of the movable dial plate in the stop state, plate springs bias the movable dial plates so as to maintain the abutment of the movable dial plates. The plate spring is pushed by a cam pin for moving the movable dial plate so as to bias the movable dial plate.

The movable dial plate is slidably disposed on a supporting plate via a slider. This manner suppresses rattling of the movable dial plates in a direction crossing the planer direction in which the movable dial plates move.

The above timepiece is provided with a member for causing the plate spring to have a biasing force and another member for preventing the rattling of the movable dial plate, separately. For this reason, the number of the parts is increased. Further, it is preferable to easily attach or remove the movable dial plates to or from the supporting plate at the time of assembling or disassembling.

It is therefore an object of the present invention to provide a clockwork mechanism and a clockwork timepiece that reduces the number of parts and improves workability of assembling and disassembling.

### SUMMARY

According to an aspect of the present invention, there is provided a clockwork mechanism including: a supporting member; a movable member including an engagement hole and movably supported by the supporting member; a drive pin engaging the engagement hole, including a flange portion for preventing the drive pin from disengaging from the engagement hole, and revolving to move the movable member; a biasing member provided in the movable member to partially overlap the engagement hole; and an abutment member abutting the movable member to restrict the movement of the movable member, wherein: the flange portion overlaps or does not overlap the biasing member depending on a revolving position of the drive pin; when the movable member abuts the abutment member, the drive pin pushes the biasing member and the movable member is biased toward the abutment member by the biasing member; and when the flange portion does not overlap the biasing member, the drive pin moves the movable member to push the biasing member, allowing the drive pin to disengage from the engagement hole.

According to another aspect of the present invention, there is provided a clockwork timepiece including the above clockwork mechanism.

### BRIEF DESCRIPTION OF THE DRAWINGS

FIGS. 1A and 1B are front views of a clockwork timepiece;

FIG. 2 is a cross sectional view of the clockwork timepiece;

FIGS. 3A and 3B are explanatory views of opening and closing actions;

FIG. 4 is an explanatory view of the opening and closing actions;

FIGS. 5A and 5B are explanatory views of the opening and closing actions;

FIGS. 6A and 6B are explanatory views of the opening and closing actions;

FIGS. 7A and 7B are explanatory views of the opening and closing actions;

FIG. 8 is an explanatory view of the opening and closing actions;

FIG. 9 is an explanatory view of the opening and closing actions;

FIGS. 10A and 10B are explanatory views of assembling a dial plate; and

FIG. 11 is a cross sectional view taken along line A-A of FIG. 3A.

### DETAILED DESCRIPTION

In the following, a description will be given of a clockwork mechanism and a clockwork timepiece according to the embodiment.

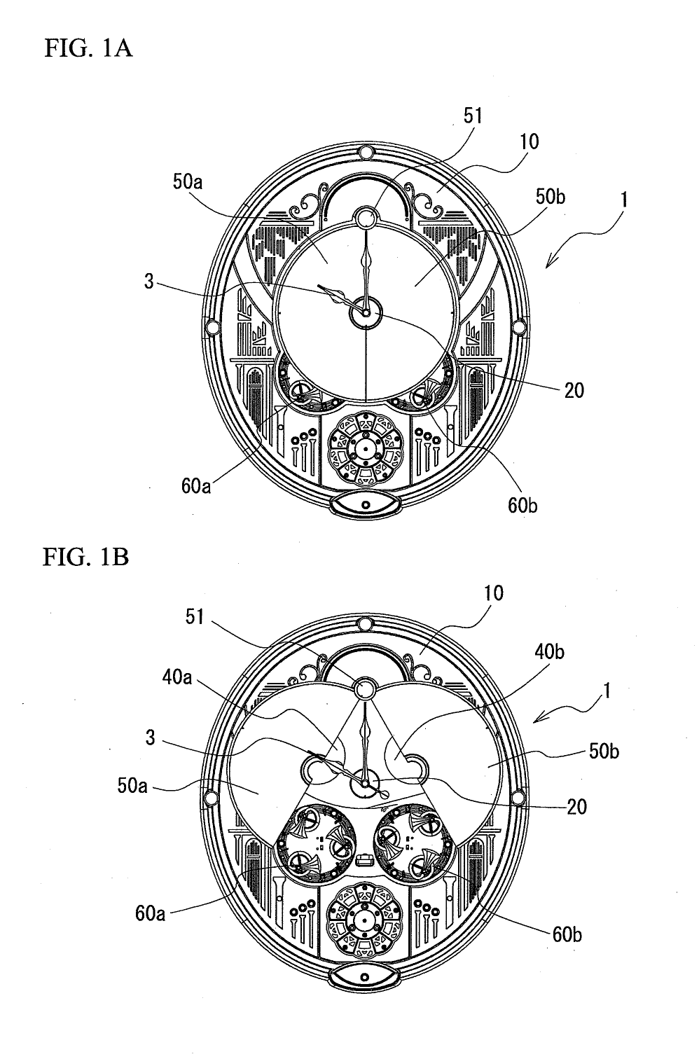

FIGS. 1A and 1B are front views of the clockwork timepiece. The clockwork timepiece 1 includes: hands 3 indicating time; a supporting plate 10; dial plates 50a and 50b movably supported by the supporting plate 10; rotary plates 60a and 60b exposed or partially covered in response to the movements of the dial plates 50a and 50b. The surfaces of the rotary plates 60a and 60b are decorated. In a normal state, the dial plates 50a and 50b close as illustrated in FIG. 1A. When a predetermined time has come, the dial plates 50a and 50b open as illustrated in FIG. 1B and the rotary plates 60a and 60b rotate. In this manner, the clockwork timepiece 1 performs at a predetermined time.

The dial plates 50a and 50b are connected to each other via a hinge portion 51. Each of the dial plates 50a and 50b is swingable about the hinge portion 51 and is a movable member with a semicircle shape. A dial plate 20 is secured to the supporting plate 10 and does not move. The hands 3 are connected to the center of the dial plate 20. The dial plate 20 has a circular shape. The hands 3 are moved by a movement not illustrated. While the performance is not conducted, the entire of the dial plates 50a, 50b, and 20 function as a single dial plate.

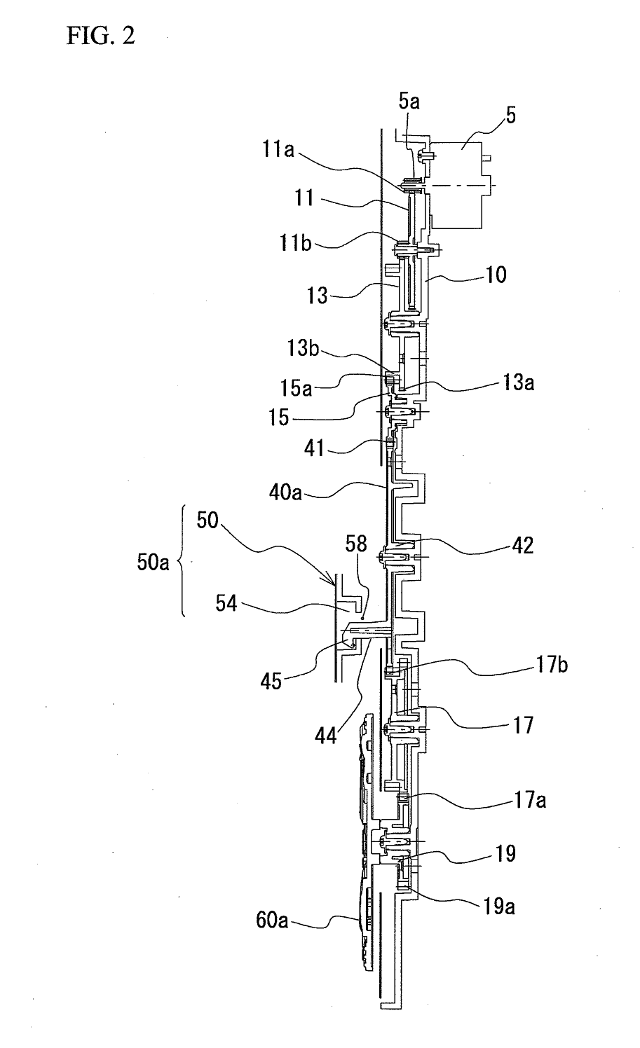

An internal structure of the clockwork timepiece 1 will be described. FIG. 2 is a cross sectional view of the clockwork timepiece. A motor 5 is disposed behind the supporting plate 10. The rotary shaft of the motor 5 extends to the front side of the supporting plate 10. A pinion gear 5a is press fitted on the motor 5. The pinion gear 5a meshes a teeth portion 11a of a gear 11. The gear 11 includes the teeth portion 11a, and a teeth portion 11b having a diameter smaller than that of the teeth portion 11a. The teeth portion 11b meshes a teeth portion 13a of a gear 13. The gear 13 includes the teeth portion 13a, and a teeth portion 13b having a diameter smaller than that of the teeth portion 13a. The teeth portion 13b meshes a teeth portion 15a of a gear 15. The teeth portion 15a meshes a teeth portion 41 of a gear 40a.

The gear 40a includes a drive pin 44, as will be described later in detail, provided apart from a shaft 42. The drive pin 44 is provided at its end with a flange portion 45. The flange portion 45 extends to the outside of the gear 40a. The drive pin 44 engages an engagement hole 54 provided in the dial plate 50a. The flange portion 45 prevents the drive pin 44 from disengaging from the engagement hole 54. In addition, the flange portion 45 is integrally formed in the drive pin 44. The gears 40a and 40b are made of plastic.

The teeth portion 41 meshes a teeth portion 17b of a gear 17. The gear 17 includes a teeth portion 17a having a diameter larger than that of the teeth portion 17b. The teeth portion 17a meshes a teeth portion 19a of a gear 19. The gear 19 is secured to the rotary plate 60a in a concentric manner. The above gears are rotatably supported by the supporting plate 10.

At the time of performance, the motor 5 rotates at a constant speed, so the gears rotate. The drive force of the motor 5 is decelerated to be transmitted to each gear. The rotation of the gear 40a causes the drive pin 44 to revolve about the shaft 42. In this way, the dial plate 50a drives. Also, the drive force of the motor 5 is transmitted to the gear 40b via the gears. Thus, during the performance, the gears 40a and 40b rotate at a constant speed.

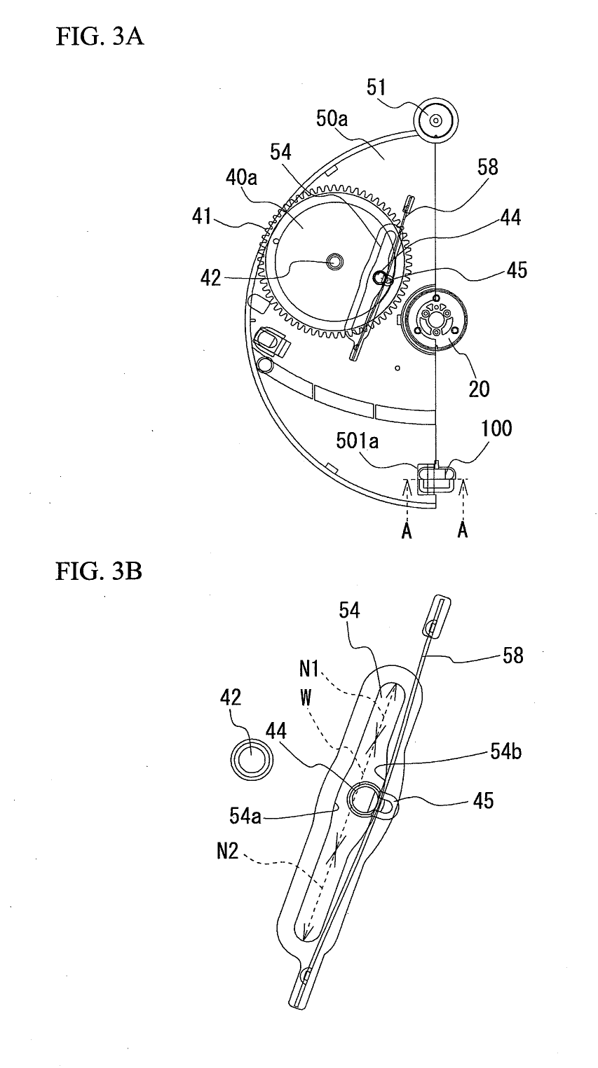

Next, the opening and closing action of the dial plates 50a and 50b will be described. FIGS. 3A to 9 are explanatory views of the opening and closing action. FIG. 3A illustrates the closing state where the dial plate 50a closes. Additionally, the dial plate 50b has the same configuration as that of the dial plate 50a, so the description thereof will be omitted.

As illustrated in FIG. 3A, the dial plate 50a is provided with the engagement hole 54 having an oblong hole shape. Further, behind the dial plate 50a, a linear spring 58 is disposed along the engagement hole 54. The both ends of the linear spring 58 are secured to the rear side of the dial plate 50a. Furthermore, FIG. 1 illustrates the state where the engagement hole 54 is covered with a cosmetic plate 50 disposed on the front surface of the dial plate 50a. Moreover, in FIGS. 3A to 9, the cosmetic plate 50 is omitted, so that the dial plate 50a is illustrated to overlap the configurations disposed behind the cosmetic plate 50, the gear 40a, and the like, for convenience.

FIG. 3B is an enlarged view of the engagement hole 54. Additionally, the structures are partially omitted in FIG. 3B. The engagement hole 54 includes narrow areas N1 and N2, and a wide area W positioned between the narrow areas N1 and N2. The narrow areas N1 and N2 are substantially identical to each other in width. The wide area W is wider than each of the narrow areas N1 and N2. The width of the narrow areas N1 or N2 is substantially identical to a diameter of the drive pin 44.

As illustrated in FIGS. 3A and 3B, the linear spring 58 is secured to the dial plate 50a so as to be arranged along the inner edges of the narrow areas N1 and N2, the inner edges being continuous with the curved portion 54b and being near the center of the dial plate 20. The wide area W is defined by curved portions 54a and 54b located outside of the inner edges of the narrow areas N1 and N2. The curved portion 54a faces the curved portion 54b. The curved portion 54b is longer than the curved portion 54a.

As illustrated in FIG. 3B, in the closing state, the drive pin 44 is located within the wide area W and pushes the linear spring 58 toward the dial plate 50b side. Therefore, the linear spring 58 is bent. As will be described later in detail, in the state where the drive pin 44 does not push the linear spring 58, the linear spring 58 has a liner shape and partially overlaps the engagement hole 54.

As mentioned above, in the closing state, the linear spring 58 is bent to have a biasing force. Thus, the dial plate 50a is biased toward the dial plate 50b by the linear spring 58. The like structure is also employed in the dial plate 50b, and the dial plate 50b is biased toward the dial plate 50a in the closing state.

The biased dial plate 50a is kept in its position in the closing state by abutting an abutment portion 501a with an abutment portion 101 of a dial plate engagement member 100. Likewise, the dial plate 50b is kept in its position in the closing state by abutting the dial plate 50b with the abutment portion 101 of the dial plate engagement member 100.

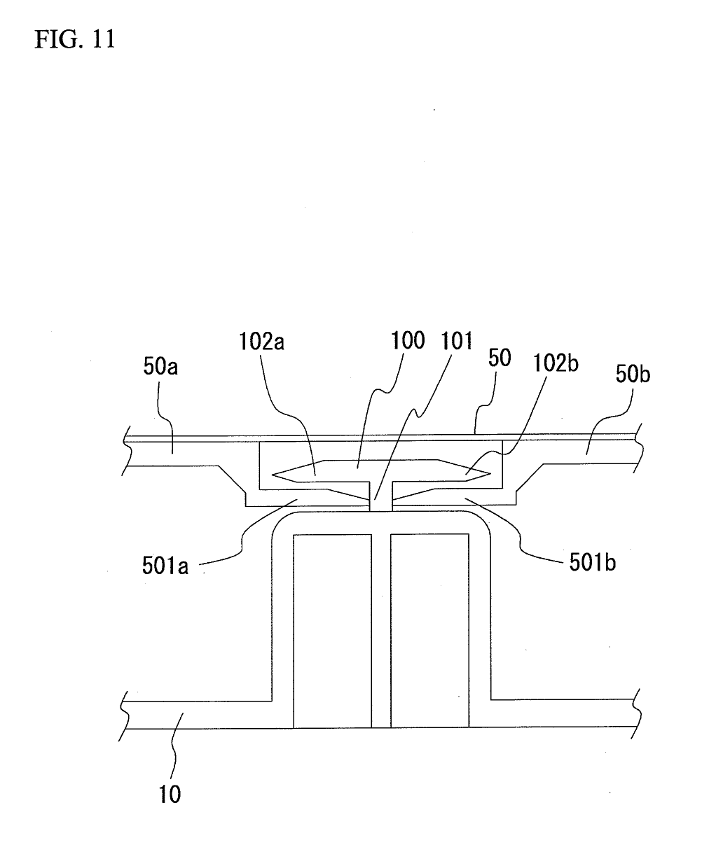

FIG. 11 is a cross sectional view taken along line A-A of FIG. 3A. Additionally, FIG. 11 illustrates some components of the structure that are not depicted in FIG. 3A. As illustrated in FIG. 11, by the abutment of the abutment portion 501a of the dial plate 50a and an abutment portion 501b of the dial plate 50b with the abutment portion 101 of the dial plate engagement member 100, the dial plates 50a and 50b are kept in their positions in the closing state. Therefore, a large clearance is prevented from generating between the dial plates 50a and 50b.

Further, extending wall portions 102a and 102b are provided above the abutment portion 101 of the dial plate engagement member 100 and extend in the direction parallel to the dial plates 50a and 50b. In the closing state where the dial plate 50a closes, the extending wall portion 102a overlaps the abutment portion 501a. With such a structure, the dial plate 50a is restricted from moving upwardly and downwardly in FIG. 11. Accordingly, the upward and downward movements of the dial plate 50a, that is, the rattling of the dial plate 50a can be restricted. The same structure also restricts the rattle of the dial plate 50b. Herein, the upward and downward movements mean the movements in the front and rear directions of the dial plates 50a and 50b.

As illustrated in FIG. 3B, when viewed from the front face of the dial plate 50a, the flange portion 45 overlaps the linear spring 58. In other words, the flange portion 45 extends outwardly from the gear 40a. The clockwork mechanism for the performance includes the dial plates 50a and 50b, the gears 40a and 40b, and the linear spring 58.

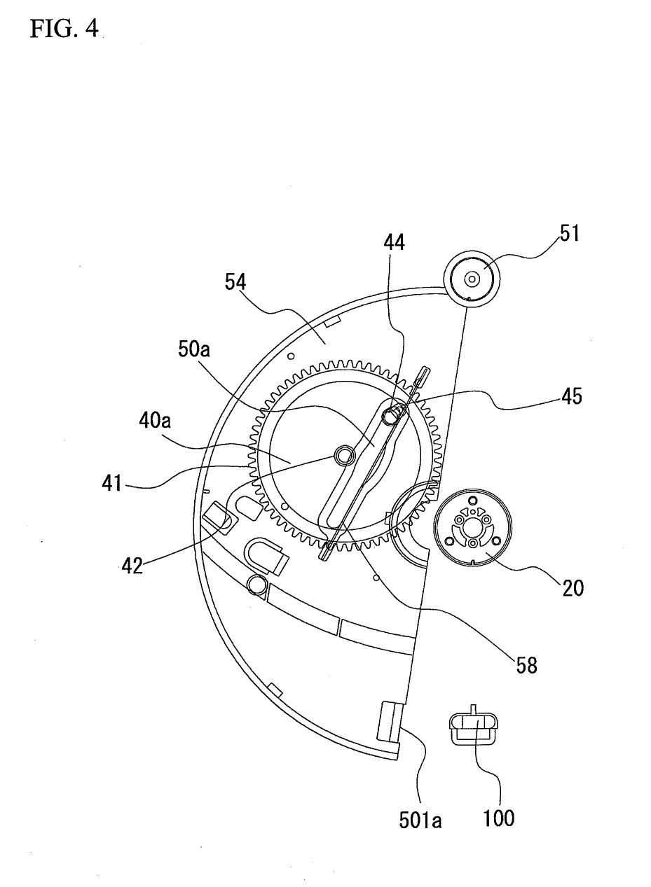

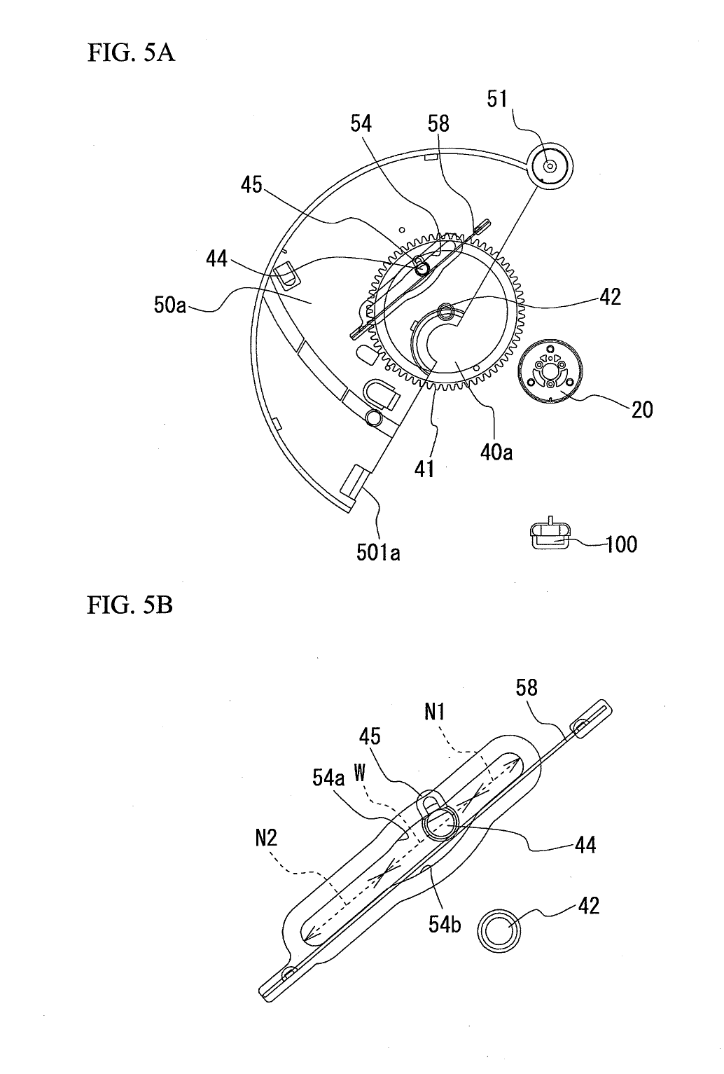

When the performance starts, the gear 40a rotates counterclockwise as illustrated in FIG. 4. Thus, the drive pin 44 moves out of the wide area W into the narrow area N1. Further, the dial plate 50a swings about the hinge portion 51 in response to the rotation of the gear 40a. That is, the dial plates 50a and 50b open. The drive pin 44 moves out of the wide area W, so that the shape of the linear spring 58 returns to the liner shape. Further, the flange portion 45 overlaps a peripheral portion of the engagement hole 54. This prevents the drive pin 44 from disengaging from the engagement hole 54. Furthermore, the flange portion 45 does not overlap the linear spring 58 in the state illustrated in FIG. 5A. In this way, the flange portion 45 overlaps or does not overlap the linear spring 58 depending on the rotational position of the gear 40a.

When the gear 40a further rotates counterclockwise, the dial plate 50a further opens in the fully opening state as illustrated in FIG. 5A. FIG. 5B is an enlarged view of the engagement hole 54 illustrated in FIG. 5A.

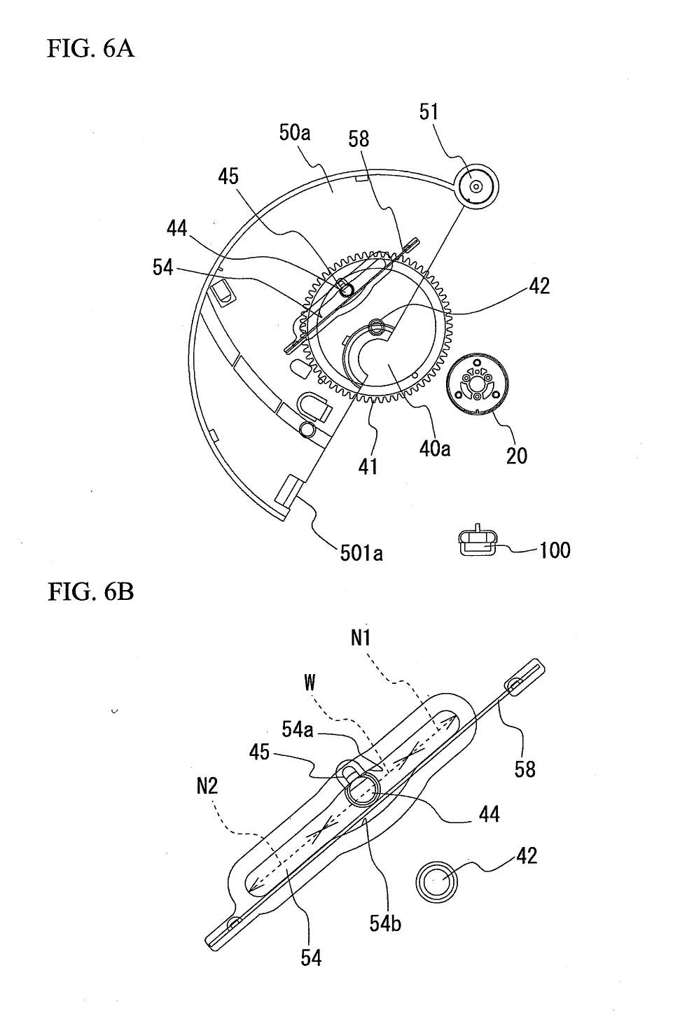

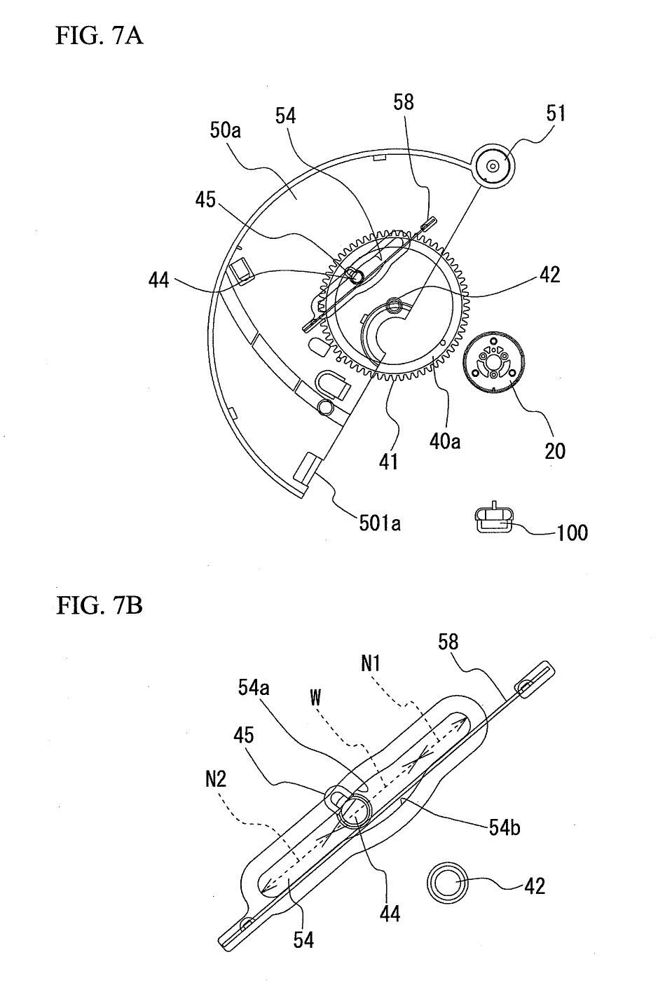

FIGS. 6A and 6B illustrate the state where the gear 40a slightly rotates counterclockwise from its position illustrated in FIG. 5A. As illustrated in FIG. 6B, the drive pin 44 is located in the center of the wide area W, and the flange portion 45 faces the outside of the clockwork timepiece 1. FIGS. 7A and 7B illustrate the state where the gear 40a slightly rotates counterclockwise from its position illustrated in FIG. 6A.

In the states as illustrated in FIGS. 5A to 7B, the gear 40a rotates counterclockwise at a constant speed, whereas the dial plate 50a does not move. That is, the curved portion 54a is formed so as to escape the revolution of the drive pin 44. In other words, the curvature radius of the curved portion 54a is substantially identical to the distance between the shaft 42 and the drive pin 44. In this way, while the drive pin 44 is moving along the curved portion 54a, the dial plate 50a is in the fully opening state in a predetermined period of time. Consequently, the dial plates 50a and 50b can be rested in the fully opening state with the simple structure. In addition, as illustrated in FIG. 5A to 7B, the linear spring 58 is not pushed by the drive pin 44 in the fully opening state. Thus, the shape of the linear spring 58 returns to a liner one.

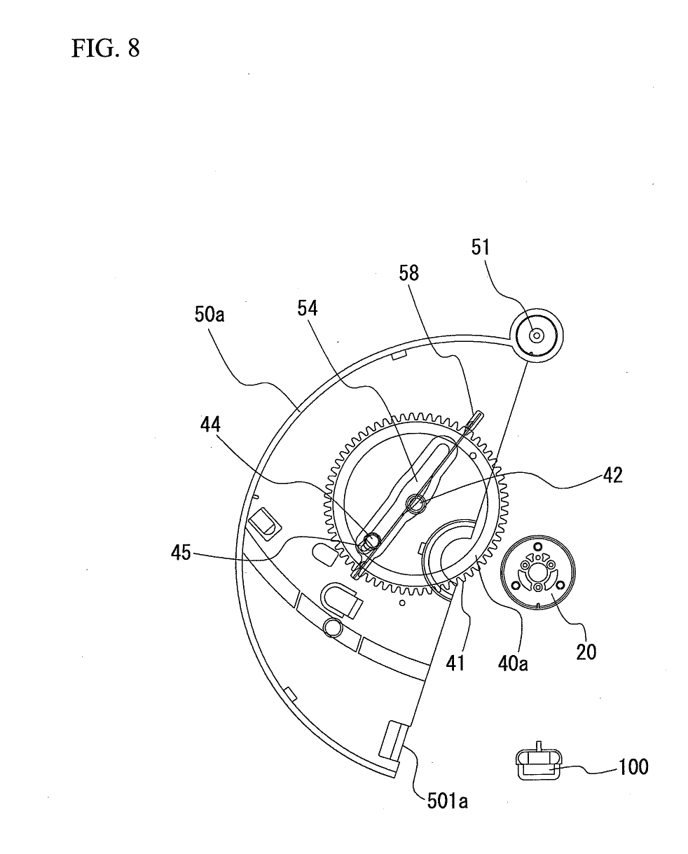

When the gear 40a further rotates counterclockwise, the drive pin 44 moves out of the wide area W into the narrow areas N2 as illustrated in FIG. 8. Thus, the dial plate 50a attempts to return to the closing position.

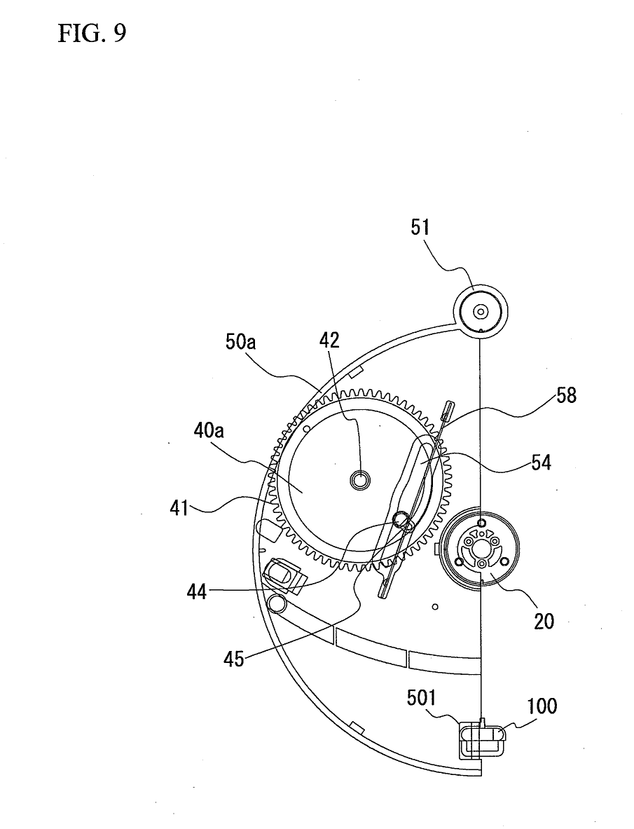

When the gear 40a further rotates, the dial plate 50a arrives at the closing position as illustrated in FIG. 9. FIG. 9 illustrates the state immediately after the dial plate 50a abuts the dial plate 50b. This state shows immediately before the drive pin 44 moving out of the narrow areas N2 into the wide area W. That is, the dial plate 50a has already returned to the closing position, immediately before the drive pin 44 moves into the wide area W.

When the gear 40a further rotates counterclockwise, the drive pin 44 moves into the wide area W. The drive pin 44 moves into the wide area W to push the linear spring 58. The dial plate 50a is biased toward the dial plate 50b by the biasing force of the linear spring 58. When the drive pin 44 arrives at the substantial center of the wide area W, the gear 40a stops. That is, the state returns to the state as illustrated in FIG. 3B, again. In this way, the gear 40a rotates once at the time of the performance. Thus, when the gear 40a stops, the linear spring 58 is biased.

As described heretofore, the drive pin 44 can push the linear spring 58 in the opening state. This is because the engagement hole 54 includes the wide area W and the linear spring 58 is arranged to partially overlap the wide area W.

Meanwhile, in the closing state where the dial plates 50a and 50b close, the rattling of the dial plates 50a and 50b is suppressed by the dial plate engagement member 100, as mentioned above. However, as the dial plates 50a and 50b open, the function of suppressing the rattling with the dial plate engagement member 100 will be lost. For example, when the dial plate 50a opens as illustrated in FIG. 4, the dial plate engagement member 100 disengages from the abutment portion 501a. Therefore, the function of suppressing the rattling with the dial plate engagement member 100 will be lost.

However, in the present embodiment, the flange portion 45 overlaps the peripheral portion of the engagement hole 54 independently of the rotational position of the gear 40a. Accordingly, the rattling of the dial plate 50a is prevented. Therefore, the rattling of the dial plate 50a is prevented, even in an area where the function of suppressing the rattling with the dial plate engagement member 100 is lost.

Consequently, the drive pin 44 has the function of causing the linear spring 58 to have the biasing force and the function of suppressing the rattle of the dial plate 50a. This arrangement reduces the number of the parts.

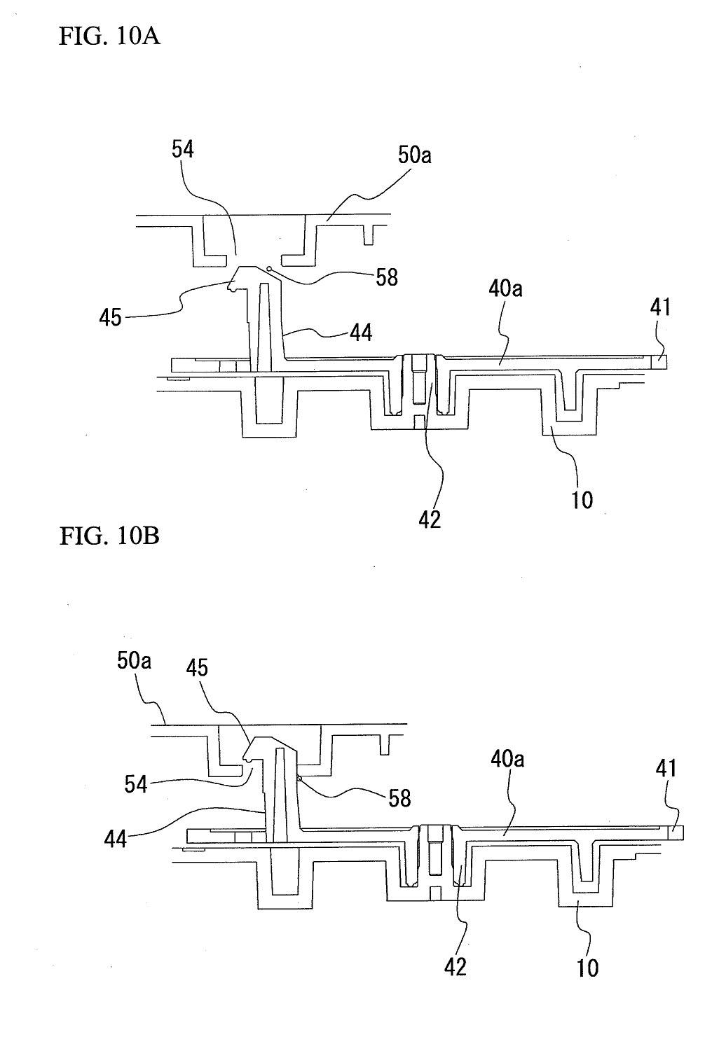

Next, the assembling of the dial plate 50a into the gear 40a will be described. FIGS. 10A and 10B are explanatory views of assembling the dial plate. FIGS. 10A and 10B illustrate cross sections in the vicinity of the drive pin 44.

First, the gear 40a is rotated to the position illustrated in FIG. 6. In this state, the drive pin 44 is inserted into the wide area W of the engagement hole 54. At the time of insertion, the drive pin 44 is inserted into the wide area W such that the extending direction of the flange portion 45 is along the width direction of the engagement hole 54 as illustrated in FIG. 6B. When the drive pin 44 is inserted into the wide area W, the linear spring 58 is pushed toward the curved portion 54b by the flange portion 45 and the drive pin 44, and the linear spring 58 is bent as illustrated in FIGS. 10A and 10B. When the hinge portion 51 is attached to a predetermined position of the supporting plate 10 in this state, the dial plate 50a is moved with respect to the drive pin 44 by the restoring force of the linear spring 58 such that the flange portion 45 overlaps the peripheral portion of the engagement hole 54. In this manner, the dial plate 50a is connected to the gear 40a in the manner as illustrated in FIG. 6B.

Accordingly, the drive pin 44 including the flange portion 45 can be inserted into the engagement hole 54 with ease. This is because the engagement hole 54 includes the wide area W. Each of the widths of the narrow areas N1 and N2 is substantially identical to a body portion of the drive pin 44. Thus, when the drive pin 44 is caused to be inserted into the narrow area N1 or N2, the flange portion 45 interferes with the narrow area N1 or N2. In the result, the drive pin 44 is not inserted into the narrow area N1 or N2. However, the drive pin 44 can be inserted into the wide area W in a predetermined posture.

Additionally, it is difficult to assemble the dial plate 50a into the gear 40a, when the rotational position of the gear 40a is not arranged at the position illustrated in FIGS. 6A and 6B. This is because the flange portion 45 interferes with the peripheral portion of the engagement hole 54 at the time of insertion.

Next, the removal of the dial plate 50a from the gear 40a will be described with reference to FIGS. 6B, 10A, and 10B. The dial plate 50a in the closing state is forcibly opened in the state as illustrated in FIG. 6B. Next, the dial plate 50a is moved such that the drive pin 44 pushes the linear spring 58 toward the curved portion 54b. In this way, the linear spring 58 is bent and removed from the engagement hole 54, and the vicinity of the drive pin 44 is shifted to the state as illustrated in FIG. 10B.

In this state, the dial plate 50a is pulled upwardly, so that the drive pin 44 disengages from the engagement hole 54 without interference of the flange portion 45 with the engagement hole 54. In this way, the dial plate 50a is removable from the gear 40a. Since the engagement hole 54 includes the wide area W, so that the assembling work is facilitated. In addition, when the dial plate 50a is disposed in the fully opening position, the dial plate 50a is attachable to or removable from the gear 40a, whereby there is a low possibility of the interference the dial plate 50a with the dial plate 20 or 50b at the time of the work.

Moreover, in the state as illustrated in FIG. 3B, the dial plate 50a is not removable from the gear 40a. The flange portion 45 overlaps the linear spring 58, and the flange portion 45 interferes with the flange portion 45 when the drive pin 44 is caused to disengage from the engagement hole 54.

At the time of the performance after the assembling, even when a certain force is exerted on the dial plate 50a by any cause in the state as illustrated in FIG. 6B such that the drive pin 44 pushes the linear spring 58, the state is returned to the state as illustrated in FIG. 6B by the repulsive force of the linear spring 58. In this manner, the linear spring 58 prevents the drive pin 44 from disengaging from the engagement hole 54 at the time of the performance.

The present invention is not limited to the specifically described embodiments and variations but other embodiments and variations may be made without departing from the scope of the claimed invention.

A plate spring may be employed instead of the linear spring 58. When the plate spring is employed, the plate spring is secured to the dial plate 50a to be bendable in the planar direction of the dial plate 50a.

A movable member may be restricted from moving by the abutment of the movable member with the stationary member, and the movable member may be biased toward the stationary member by a biasing member.

In the present embodiment, the gear 40a is used for driving the dial plate 50a. However, the present invention is not limited to this configuration. For example, the dial plate 50a may be driven by an arm rotating about a predetermined position and provided with a drive pin.

What is claimed is:

1. A clockwork mechanism comprising:
a supporting member;
a movable member including an engagement hole and movably supported by the supporting member;
a drive pin engaging the engagement hole, including a flange portion for preventing the drive pin from disengaging from the engagement hole, and revolving to move the movable member;
a biasing member provided in the movable member to partially overlap the engagement hole; and
an abutment member abutting the movable member to restrict the movement of the movable member,
wherein:
the flange portion overlaps or does not overlap the biasing member depending on a revolving position of the drive pin;
when the movable member abuts the abutment member, the drive pin pushes the biasing member and the movable member is biased toward the abutment member by the biasing member; and
when the flange portion does not overlap the biasing member, the drive pin moves the movable member to push the biasing member, allowing the drive pin to disengage from the engagement hole.

2. The clockwork mechanism of claim 1, wherein:
the engagement hole has an oblong shape and includes a narrow area and a wide area;
the biasing member is arranged along an inner edge of the narrow area;
when the drive pin is located in the wide area and the flange portion does not overlap the biasing member, the drive pin moves the movable member to push the biasing member, allowing the drive pin to disengage from the engagement hole.

3. The clockwork mechanism of claim 2, wherein the wide area escapes revolution of the drive pin.

4. A clockwork timepiece comprising a clockwork mechanism including:
a supporting member;
a movable member including an engagement hole and movably supported by the supporting member;
a drive pin engaging the engagement hole, including a flange portion for preventing the drive pin from disengaging from the engagement hole, and revolving to move the movable member;
a biasing member provided in the movable member to partially overlap the engagement hole; and
a abutment member abutting the movable member to restrict the movement of the movable member,
wherein:
the flange portion overlaps or does not overlap the biasing member depending on a revolving position of the drive pin;
when the movable member abuts the abutment member, the drive pin pushes the biasing member and the movable member is biased toward the abutment member by the biasing member; and
when the flange portion does not overlap the biasing member, the drive pin moves the movable member to push the biasing member, allowing the drive pin to disengage from the engagement hole.
